(19) United States
(12) Patent Application Publication
(10) Pub. No.: US 2006/0215213 A1
(43) Pub. Date: Sep. 28, 2006

(54) Printing device and print control method

(75) Inventor: Osamu Kagita, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/365,856

(22) Filed: Mar. 2, 2006

(30) Foreign Application Priority Data
Mar. 2, 2005 (JP) P2005-056975

(51) Int. Cl. G06K 15/00

(52) U.S. Cl. 358/1.14; 358/1.15

(57) ABSTRACT

A printing device does not perform a flying print during a manual duplex print and performs a process for discharging a sheet of a page even when a memory deficient error or a data abnormal error arises during the process of any of pages in the manual duplex print.

### BACKGROUND OF THE INVENTION

1. Technical Field of the Invention

The present invention relates to a printing device and a print control method.

2. Description of the Related Art

As well-known, some of the printing devices can perform a duplex printing operation. Such kinds of printing devices include a printing device in which a unit is incorporated for automatically turning over sheets during the duplex printing operation and a printing device in which such a unit is not incorporated.

In the printing device in which the above-described unit is not incorporated, when the duplex printing operation is carried out, sheets whose front surfaces are merely printed are temporarily outputted and the bundle of the sheets is set on a sheet discharge tray by a user, and then, the back surfaces of the sheets are printed. The duplex print in which a work for turning over the sheets is imposed on the user is ordinarily referred to as a manual duplex print.

In ordinary printing devices, when a print error is generated, a process for overcoming the error is carried. Specifically, in what is called a flying print that print data is received simultaneously with the formation of image data from the print data, when the print error or the so-called an over-run that an image is depicted before the data is completely formed arises, a sheet subsequent to a page in which the error is generated is reprinted (recovery print). Further, when the print error that the image data for one page is not prepared due to the deficiency of a memory or the print error that there is an abnormality in the image data is generated, the print of the page is cancelled, the sheets are not discharged and a next page is printed.

In the manual duplex print as described above, when the recovery print is carried out, all pages after the recovery page are printed on sheets subsequent to the sheets that are to be originally printed. Further, when the print of a page is cancelled due to the deficiency of a memory or the abnormality of data generated during the process of any of the pages, all pages subsequent to the cancelled page are undesirably printed on sheets before sheets to be originally printed.

As described above, when the process is carried out for meeting the print error during the execution of the manual duplex print, sheets whose pages shift in front and back surfaces are inconveniently included in printed products by the manual duplex printing operation. Thus, not only the page in which the error arises, but also all the pages after the page in which the error is generated (and a page to be printed on a printing surface opposite to the printing surface of the page) need to be manually perfectly printed again.

In the printing device that performs what is called an automatic duplex print by using the unit for automatically turning over sheets during the duplex printing operation, the front surface and the back surface of one sheet are completely printed, a next sheet begins to be printed. Accordingly, even when the print error arises during the printing operation of any of sheets, the recovery print many be performed to the sheet. Therefore, the above-described problem of a page shift in the manual duplex print does not arise.

### SUMMARY OF THE INVENTION

The present invention is proposed by considering the above-described problems of the related art and it is an object of the present invention to save an operation for reprinting pages after a page in which an error is generated even when the print error is generated during the execution of a manual duplex print.

A printing device proposed to solve the above-described problems comprises: a print mechanism for printing data on a sheet; a memory for storing flying print setting information that defines whether a flying print function is made to be valid or invalid; a receiver for receiving a print request from a host computer through a communicator; a discriminator for discriminating whether the execution of a manual duplex print is instructed or not in the print request received by the receiver; a setting switcher for switching the flying print setting information in the memory to an invalidity when the discriminator decides that the execution of the manual duplex print is instructed in the print request; and a print controller that controls the print mechanism to perform a printing process corresponding to the print request received by the receiver in accordance with the setting information in the memory, and discharges the sheet of a page when a memory deficient error or a data abnormal error arises during the process of any of pages in the printing process in case the discriminator decides that the execution of the manual duplex print is instructed in the print request.

With such a construction, since the flying print is not carried out during the manual duplex print, an over-run based on the deficiency of a memory during depicting an image or the abnormality in forming data does not arise in the first place during the manual duplex printing operation, and further, the recovery print is not carried out to a sheet subsequent to a page in which an error is generated. Further, even when the memory deficient error or the data abnormal error arises during the process of any of pages in the manual duplex print, a process for discharging the sheet of the page is performed. Accordingly, the pages after the page in which the error arises are printed on proper sheets.

Therefore, according to the present invention, even when the print error arises during the execution of the manual duplex printing operation, the pages after the page in which the error is generated do not need to be reprinted and only the page in which the error is generated (and a page to be printed on its printing surface opposite to the printing surface of the page) may be reprinted by the manual duplex printing operation.

### BRIEF DESCRIPTION OF THE DRAWINGS

FIG. 1 is a block diagram of a printing device of a first embodiment; and

FIG. 2 is a diagram showing a flow of processes performed by a CPU in accordance with a print request transmitted from a host computer.

### DETAILED DESCRIPTION OF THE INVENTION

Now, two examples of a printing device as modes for carrying out the present invention will be described below by referring to the accompanying drawings.

### First Embodiment

Initially, the structure of a printing device of a first embodiment will be described.

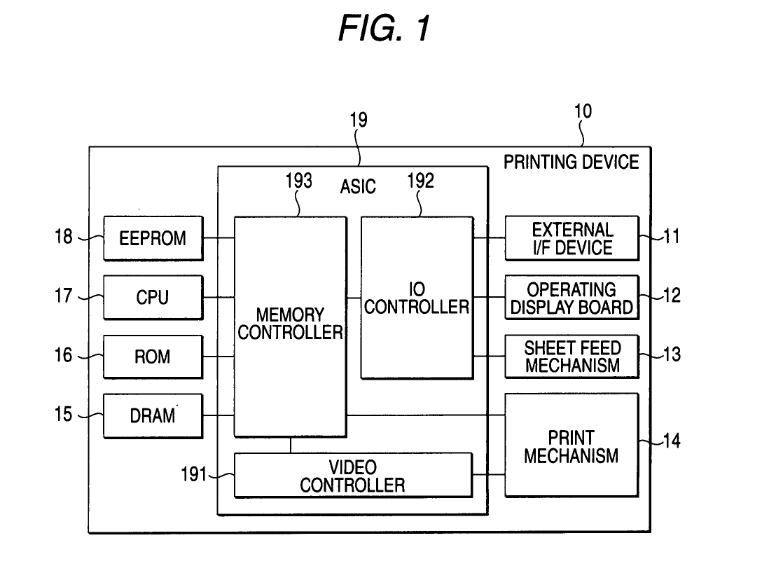

FIG. 1 is a block diagram of the printing device 10 of the first embodiment. The printing device 10 is a device for receiving a print request from a host computer not shown in the drawing to operate and incorporates, as a main structure, an external I/F device 11, an operating display board 12, a sheet feed mechanism 13, a print mechanism 14, a DRAM 15, a ROM 16, a CPU 17, an EEPROM 18 and an ASIC 19.

The external I/F device 11 is what is called a communication interface port for receiving the print request from the host computer that is not shown in the drawing.

The operating display board 12 is a device for receiving various kinds of instructions from a user or displaying various kinds of screens and is provided with push buttons or touch screens.

The sheet feed mechanism 13 is a mechanism for feeding one or more kinds of sheets to the print mechanism 14 and is provided with some slots to which sheet cassettes are detachably attached. The print mechanism 14 is a mechanism for actually printing data on the sheets supplied from the sheet feed mechanism 13.

The DRAM “Dynamic Random Access Memory” 15 serves as a temporary storage area of the print request transmitted from the host computer not shown in the drawing and is a volatile memory used as a working area when various kinds of processes are performed in accordance with the print request.

The ROM “Read Only Memory” 16 is a nonvolatile memory that stores a program for controlling the printing device 10 or font data used when image data is formed on the basis of print data in the print request.

The CPU “Central Processing Unit” 17 is a control circuit for generally controlling respective parts in accordance with the program in the ROM 16. Specifically, the CPU 17 performs processes for obtaining instructions of processes to be executed from a user through operations to the buttons or the touch screens of the operating display board 12 provided on the upper surface of the printing device 10 or a print control process for controlling the print mechanism 14 to perform a printing process corresponding to the print request transmitted from the host computer not illustrated.

The EEPROM “Electrically Erasable and Programmable Read Only memory” 18 is what is called a flash memory for holding various kinds of settings related to a printing after a power is turned off.

In the first embodiment, the EEPROM 18 stores flying print mode information for defining whether a flying print function is made to be valid or invalid. When the flying print function is invalid, after the image data for one page is completely formed, a print image shown by the image data is depicted on a sheet. When the flying print function is valid, before the image data for one page is completely formed, the print image is depicted on a sheet (the image data is formed and the print image is depicted at the same time). Accordingly, when the flying print function is valid, a memory deficiency or the abnormal formation of data may possibly arise during depicting the print image. However, the printing process can be carried out at high speed.

Further, the EEPROM 18 stores automatic error cancel mode information for defining whether an automatic error cancel function is made to be valid or invalid. When the automatic error cancel function is invalid, an error state generated due to an over-run error during a flying print operation, a memory deficient error or a data abnormal error is manually cancelled to resume an operation. When the automatic error cancel function is valid, the error state generated due to these errors is automatically cancelled after a prescribed time elapses and the operation is resumed. Accordingly, when the automatic error cancel function is valid, an operation for canceling the error state does not need to be carried out.

Since the EEPROM 18 stores the above-described mode information, the EEPROM 18 corresponds to the above-described memory.

The ASIC “Application Specific Integrated Circuit” 19 is a semiconductor integrated circuit for controlling the transmission and reception of data or instructions between hardware 11 to 18 and connected to the hardware 11 to 18 respectively. The ASIC 19 is provided with a video controller 191, an IO controller 192 and a memory controller 193 as interfaces between the hardware 11 to 18.

The video controller 191 is a circuit module for converting the image data to be supplied to the print mechanism 14 to an electric signal with a form that can be processed by a scanning unit not shown in the print mechanism 14.

The IO controller 192 is a circuit module for controlling the external I/F device 11, the operating display board 12 and the sheet feed mechanism 13. The IO controller 192 also serves as a circuit module for directly transferring the print request transmitted from the host computer not illustrated to the DRAM 15 from the external I/F device 11.

The memory controller 193 is a circuit module having a function for controlling the reading and writing of a program or data relative to the DRAM 15, a function for controlling the reading of a program or data from the ROM 16 and a function for controlling a controller not shown in the print mechanism 14.

Now, processes performed by the printing device 10 will be described below when the print request is transmitted from the host computer not shown in the drawing.

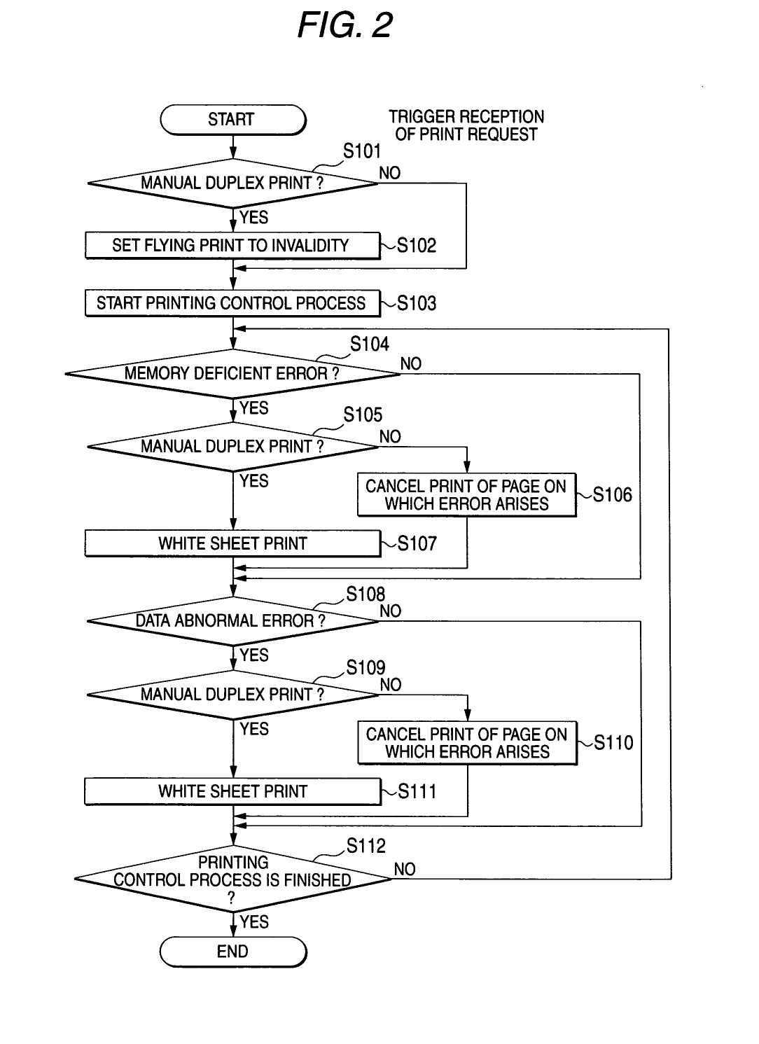

In the printing device 10, when the print request is transmitted from the host computer not illustrated, the IO controller 192 in the ASIC 19 transfers the print request to the DRAM 15 from the external I/F device 11. Accordingly, the IO controller 192 in the ASIC 19 or the external I/F device 11 function as a receiver. Then, after a DMA transfer is performed, the CPU 17 reads a prescribed program from the ROM 16 to start a process. FIG. 2 is a diagram showing a flow of processes performed by the CPU 17 at this time.

Firstly, the CPU 17 discriminates whether or not a manual duplex print is instructed in the print request temporarily stored in the DRAM 15 (step S101). Specifically, the CPU 17 discriminates whether or not a manual duplex print designating command is included in a header of the received print request. The CPU 17 performing the step S101 corresponds to the above-described discriminator.

When the manual duplex print is not instructed (S101: NO) in the print request, the CPU 17 reads the flying print mode information and the automatic error cancel mode information to the DRAM 15 from the EEPROM 18 to start a printing control process in accordance with the print request in output forms corresponding to the information in the DRAM 15 (S103). The printing control process is carried out in parallel with the processes shown in FIG. 2.

On the other hand, when the manual duplex print is instructed in the print request (S101: YES), the CPU 17 reads the flying print mode information to the DRAM 15 from the EEPROM 18 and forcedly changes the contents of the flying print mode information recorded in the DRAM 15 to an invalidity (S102). Then, the CPU 17 starts a printing control process in accordance with the print request in an output form corresponding to the flying print mode information in the DRAM 15 (S103). The printing control process is carried out in parallel with the processes shown in FIG. 2.

After the printing control process is started (S103), the CPU 17 waits for the detection of the memory deficient error or the data abnormal error until the printing control process is finished (S104; NO, S108; NO, S112; NO).

Then, under a waiting state, when the memory deficient error is detected during the printing process of any of pages (S104: YES), if the print request whose printing control process is carried out does not instruct the manual duplex print (S105; NO), the CPU 17 cancels the printing process of the page and does not perform a sheet discharge process (S106). When the print request whose printing control process is carried out instructs the manual duplex print (S105; YES), the CPU 17 carries out a process for discharging the sheet of the page (S107) and returns to a stand-by state again (S104; NO, S108; NO, S112; NO).

Further, under the stand-by state, when the data abnormal error is detected during the printing process of any of pages (S108; YES), if the print request whose printing control process is carried out does not instruct the manual duplex print (S109; NO), the CPU 17 cancels the printing process of the page and does not discharge the sheet (S110). When the print request whose printing control process is carried out instructs the manual duplex print (S109; YES), the CPU 17 carries out a process for discharging the sheet of the page (S111) and returns again to the stand-by state (S104; NO, S108; NO, S112; NO).

The, under the stand-by state, when the printing control process is finished (S112; YES), the CPU 17 finishes the processes shown in FIG. 2.

Now, an operation and effects of the printing device 10 of the first embodiment will be described below.

When a user does not designate the manual duplex print and instructs a printing operation to be performed in the host computer not illustrated, the print request in which the manual duplex print designating command is not included in the header is transmitted to the printing device 10 from the host computer not illustrated.

When the printing device 40 receives the print request, since the manual duplex print is not instructed, the printing device 10 performs a single side print in an output form corresponding to the contents of a setting recorded in the EEPROM 18 (S101; NO, S103). That is, when the flying print mode information is valid in the EEPROM 18, the single side print is carried out as a flying print. When the flying print mode information is invalid, an ordinary single side print is carried out. Further, when the automatic error cancel mode information is valid, even if the memory deficient error or the data abnormal error arises during the printing process of any of the pages, an error state is automatically cancelled after a prescribed time elapses. When the automatic error cancel mode information is invalid, if the memory deficient error or the data abnormal error arises during the printing process of any of the pages, an operation is stopped at that time.

In the single side print, when the memory deficient error or the data abnormal error arises during the printing process of any of the pages, the page is not printed and the sheet is not discharged (S104; Yes, S105; NO, S106, S108; YES, S109; NO, S110).

On the other hand, when the user designates the manual duplex print and instructs the printing operation to be performed in the host computer not illustrated, the print request in which the manual duplex print designating command is included in the header is transmitted to the printing device 10 from the host computer not illustrated.

When the printing device 10 receives the print request, since the manual duplex print is instructed, even if the contents of the flying print mode information are set to a validity in the EEPROM 18, the printing device forcedly changes the contents of the flying print mode information to an invalidity (S101; YES, S102).

Then, in the printing control process started thereafter, since the flying print is not carried out, the over-run based on the deficiency of a memory during depicting an image or the abnormality in forming data does not originally arise and a reprint (recovery print) is not carried out on a page subsequent to a page in which the error arises. As a result, a phenomenon doe not occur that all pages after a recovery page are printed on sheets subsequent to the sheets to be originally printed as in a usual case. Thus, the pages after the page in which the error is generated are properly printed on the sheets to be originally printed.

Further, in the manual duplex print, when the memory deficient error or the data abnormal error arises during the printing process of any of pages, the page is not printed, however, the sheet of the page is discharged (S105; YES, S106; YES, S108, S109; YES, S110; YES, S112). As a result, a phenomenon doe not occur that all pages after the cancelled page are printed on sheets before the sheets to be originally printed as in a usual case. Thus, the pages after the page in which the error is generated are properly printed on the sheets to be originally printed.

Consequently, even when the print error arises during performing the manual duplex print, the user may reprint only the error generating page that is printed as a white sheet (and a page to be printed on its printing surface opposite to the printing surface of the page) by the manual duplex printing operation.

In the above-described first embodiment, the printing device 10 decides whether or not the flying print mode is to be forcedly changed to invalidity. However, the present invention is not limited thereto. For instance, a printer driver of the host computer not illustrated may forcedly change the flying print mode to invalidity in accordance with whether or not the manual duplex print is instructed from the user. In this case, information to the effect that the mode is forcedly changed to invalidity is transmitted to the printing device 10 together with the print request. The printing device 10 receives the information to forcedly temporarily change the mode to the invalidity.

Further, in the above-described first embodiment, every time the memory deficient error or the data abnormal error arises during the printing control process, the printing device 10 decides whether or not the print request whose printing control process is carried out designates the manual duplex print. The present invention is not limited thereto. For instance, the printing device 10 may store in the EEPROM 18 setting information for defining whether a print is cancelled or a white sheet print is carried out when the memory deficient error or the data abnormal error is detected. During the printing control process, the printing process may be carried out in an output form corresponding to the setting information. In this case, after the printing device 10 receives the print request, when the manual duplex print designating command is included in the print request (S101; YES), the printing device 10 forcedly changes the setting information that defines an operation to be adopted when the memory deficient error or the data abnormal error is detected to “carry out a white sheet print” as in the case that the printing device forcedly changes the flying print mode to invalidity (S102). After the printing control process is started, the steps (S105, S109) for deciding whether or not the print request designates the manual duplex print are not performed.

### Second Embodiment

In a second embodiment, when the manual duplex print is instructed to be performed, a flying print mode is not forcedly changed to invalidity as in the first embodiment, and an automatic error cancel mode is forcedly changed to invalidity.

Specifically described, in a printing device 10, when a print request is transmitted from a host computer not shown in the drawing, an IO controller 192 in an ASIC 19 DMA transfers the print request to a DRAM 15 from an external I/F device 11. The, the DMA transfer is carried out, a CPU 17 reads a prescribed program from a ROM 16 to start a process.

In the process, the CPU 17 initially discriminates whether or not the manual duplex print is instructed in the print request temporarily stored in the DRAM 15.

Then, when the manual duplex print is not instructed in the print request, the CPU 17 reads flying print mode information and automatic error cancel mode information to the DRAM 15 from an EEPROM 18 and starts a printing control process corresponding to the print request in an output form in accordance with the information in the DRAM 15.

On the other hand, when the manual duplex print is instructed in the print request, the CPU 17 reads the automatic error cancel mode information to the DRAM 15 from the EEPROM 18, and then, forcedly changes the contents of the automatic error cancel mode information recorded in the DRAM 15 to invalidity. Then, the CPU 17 starts the printing control process corresponding to the print request in the output form in accordance with the automatic error cancel mode information in the DRAM 15.

Since a structure is provided so as to carry out the above-described processes, when the printing device 10 of the second embodiment receives the print request for instructing the manual duplex print, even if the contents of the automatic error cancel mode information are set to validity in the EEPROM 18, the contents of the automatic error cancel mode information are forcedly changed to invalidity.

Then, since an automatic error cancel is not carried out during performing the manual duplex print, when a memory deficient error or a data abnormal error arises, or when an over-run in a flying print arises, an operation stops at that time. Accordingly, the stop of the operation informs a user of the occurrence of the error, and the user needs to cancel an error state.

As a result, the user removes a sheet having a page printed on which the error arises or a sheet on which a printing operation is cancelled to adjust pages after the page on which the error arises so that the pages can be properly printed on sheets to be originally printed. Further, the user may reprint thereafter the removed page (and a page to be printed on its printing surface opposite to the printing surface of the page) by the manual duplex printing operation.

Also in the second embodiment, the printing device 10 or a printer driver of the host computer not illustrated may decide whether or not the automatic error cancel mode is to be forcedly changed to invalidity. In the case of the latter, when the printer driver is instructed to perform the manual duplex print from the user, information to the effect that the automatic error cancel mode is forcedly changed to invalidity is transmitted to the printing device 10 together with the print request.

What is claimed is:

1. A printing device comprising:
a print mechanism that prints data on a sheet;
a memory that stores flying print setting information which defines whether a flying print function is made to be valid or invalid;
a receiver that receives a print request from a host computer through a communicator;
a discriminator that discriminates whether an execution of a manual duplex print is instructed or not in the print request received by the receiver;
a setting switcher that switches the flying print setting information in the memory to an invalidity when the discriminator decides that the execution of the manual duplex print is instructed in the print request; and
a print controller that: controls the print mechanism to perform a printing process corresponding to the print request received by the receiver in accordance with the setting information in the memory; and discharges, when a memory deficient error or a data abnormal error arises during the process of any of pages in the printing process in a case where the discriminator decides that the execution of the manual duplex print is instructed in the print request, a sheet of the page.

2. The printing device according to claim 1, wherein the memory further stores an automatic error cancel mode information which defines whether an automatic error cancel function is made to be valid or invalid

3. A printing device comprising:
a print mechanism that prints data on a sheet;
a memory that stores flying print setting information that defines whether a flying print function is made to be valid or invalid;
a receiver that receives a print request from a host computer through a communicator;
a discriminator that discriminates whether an execution of a manual duplex print is instructed or not in the print request received by the receiver;
a setting switcher that switches the flying print setting information in the memory to an invalidity when the discriminator decides that the execution of the manual duplex print is instructed in the print request; and
a print controller that controls the print mechanism to perform a printing process corresponding to the print request received by the receiver in accordance with the setting information in the memory.

4. The printing device according to claim 3, wherein the memory further stores an automatic error cancel mode information which defines whether an automatic error cancel function is made to be valid or invalid

5. A printing device comprising:
a print mechanism that prints data on a sheet;
a receiver that receives a print request from a host computer through a communicator;
a discriminator that discriminates whether an execution of a manual duplex print is instructed or not in the print request received by the receiver; and
a print controller that: controls the print mechanism to perform a printing process corresponding to the print request received by the receiver; and discharges, when a memory deficient error or a data abnormal error arises during the process of any of pages in the printing process in a case where the discriminator decides that the execution of the manual duplex print is instructed in the print request, a sheet of the page.

6. A print control method, comprising
receiving a print request;
discriminating whether an execution of a manual duplex print is instructed or not in the print request;
switching a flying print function to invalidity to set a print condition, when the execution of the manual duplex is instructed; and
starting a print control processing based on the print condition.

7. The print control method according to claim 6, further comprising:
detecting a memory deficient error or a data abnormal error.

8. The print control method according to claim 6, wherein in a case where the memory deficient error or the data abnormal error is detected, the print control processing is varied based on the discriminating.

9. The print control method according to claim 8, wherein when the execution of the manual duplex is instructed, a sheet of a page in which the memory deficient error or the data abnormal error is detected is discharged without printing.

10. The print control method according to claim 8, wherein when the execution of the manual duplex is not instructed, a printing of a sheet of a page in which the memory deficient error or the data abnormal error is detected is cancelled.

11. A print control method, comprising
receiving a print request;
discriminating whether an execution of a manual duplex print is instructed or not in the print request;
switching an automatic error cancel function to invalidity to set a print condition, when the execution of the manual duplex is instructed; and
starting a print control processing based on the print condition.

12. The print control method according to claim 11, further comprising:
detecting a memory deficient error or a data abnormal error.

13. The print control method according to claim 12, wherein in a case where the memory deficient error or the data abnormal error is detected, print operation stops and a user is informed of the occurrence of the error.
